(19) United States
(12) Patent Application Publication
(10) Pub. No.: US 2005/0157985 A1
(43) Pub. Date: Jul. 21, 2005

(54) Snap-on assembly

(75) Inventors: Michael J. McGowan SR., Barrington, NJ (US); Charles R. Hurst JR., Bullard, TX (US); Christopher F. Lumpkin, Evergreen, CO (US)

Correspondence Address: SYNNESTVEDT & LECHNER, LLP, 2600 ARAMARK TOWER, 1101 MARKET STREET, PHILADELPHIA, PA, 191072950, US

(73) Assignee: Innovatech Surgical, Inc., Camden, NJ (US)

(21) Appl. No.: 10/927,740

(22) Filed: Aug. 27, 2004

Related U.S. Application Data
(60) Provisional application No. 60/499,750, filed on Sep. 3, 2003.

(51) Int. Cl. G02B 6/36

(52) U.S. Cl. 385/88

(57) ABSTRACT

An adapter for connecting a light source to a connector of an optic fiber instrument is described. The adapter includes a sleeve having an external surface configured to fit inside a portion of the connector. The external surface of the sleeve includes a groove that is positioned to engage a tube located inside the connector. Accordingly, when the sleeve is inserted inside the connector, the tube catches the groove thereby coupling the adapter to the connector.

### CROSS-REFERENCE TO RELATED APPLICATIONS

The present patent application claims benefit of U.S. Provisional Application Ser. No. 60/490,750 filed on Sep. 3, 2003. The content of the aforementioned application is fully incorporated by reference herein.

### TECHNICAL FIELD

The present invention relates generally to a snap-on assembly used to connect a light source to an optic fiber instrument.

### BACKGROUND

Medical laser systems used to treat ophthalmologic disorders and other possible medical conditions often consist of a light source and microsurgical instrument. The light source typically generates light that is transmitted to the microsurgical instrument via a fiber optic cable. The fiber optic cable is usually detachably connected to the light source, to enable replacement of one microsurgical instrument for another.

There are problems associated with the way in which the light source and microsurgical instrument are connected and disconnected from each other. For instance, some devices use screw threading to attach the light source to the microsurgical instrument. This technique requires repeated rotations of the screw connection, which is time consuming to attach and detach. Other techniques use BNC styled connectors to attach and detach the light source and microsurgical instrument. BNC styled connectors were borrowed from the telecommunication industry, but have been found to be susceptible to open circuits when there is movement of either the light source and microsurgical instrument. An open circuit between the light source and microsurgical instrument can result in the failure or erratic performance of the microsurgical instrument during a surgical procedure.

### SUMMARY

An adapter for connecting a light source to a connector of an optic fiber instrument is described. In one implementation, the adapter includes a sleeve having an external surface configured to fit inside a portion of the connector. The external surface of the sleeve includes a groove that is positioned to engage a tube located inside the connector. Accordingly, when the sleeve is inserted inside the connector, the tube catches the groove thereby coupling the adapter to the connector.

### BRIEF DESCRIPTION OF THE DRAWINGS

The detailed description is described with reference to the accompanying figures. In the figures, the left-most digit(s) of a reference number identifies the figure in which the reference number first appears. It should be noted that the figures are not necessarily drawn to scale and are for illustration purposes only.

FIG. 1 is an exploded side view of an assembly for connecting a connector of an optic fiber instrument to a connector of a light source.

FIG. 2 is a side view of an exemplary optic fiber instrument.

FIG. 3 is a magnified side view of an exemplary connector.

FIG. 4 is another side view of an exemplary connector that is rotated ninety degrees from the view depicted in FIG. 3.

FIGS. 5 and 6 are cross-sectional views of a connector of an optic fiber instrument.

FIG. 7 shows a longitudinal-sectional view of an adapter with tubes engaged in a groove of the adapter.

FIG. 8 shows a side view of the connector and a perspective view of an alternative implementation of the adapter including posts.

FIG. 9 illustrates a cross-sectional side view of the exemplary adapter shown in FIG. 8, used for connecting and disconnecting a connector of a fiber optic instrument to a connector of a light source.

### DETAILED DESCRIPTION

Introduction

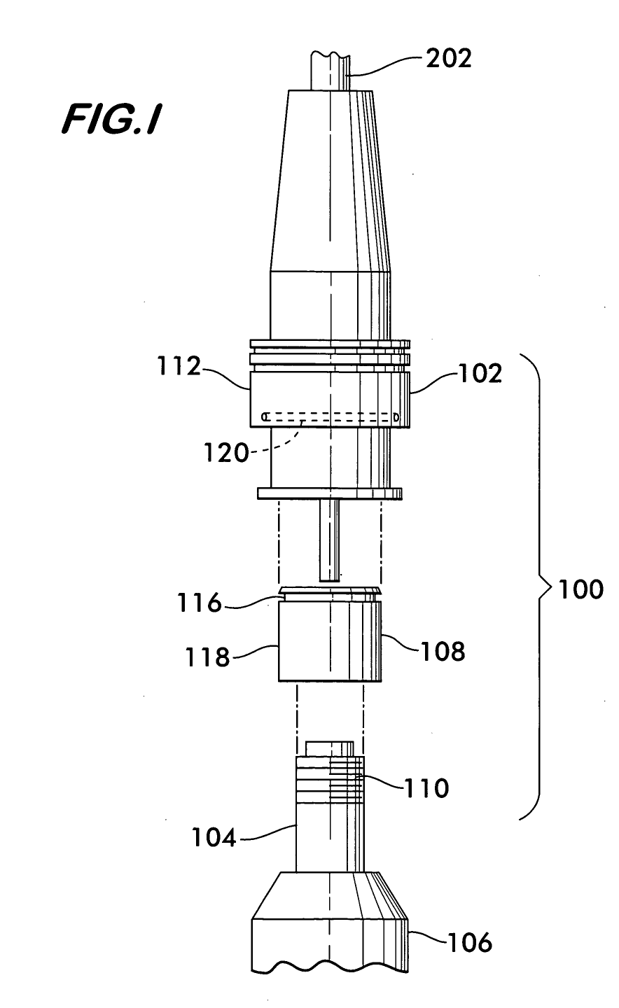

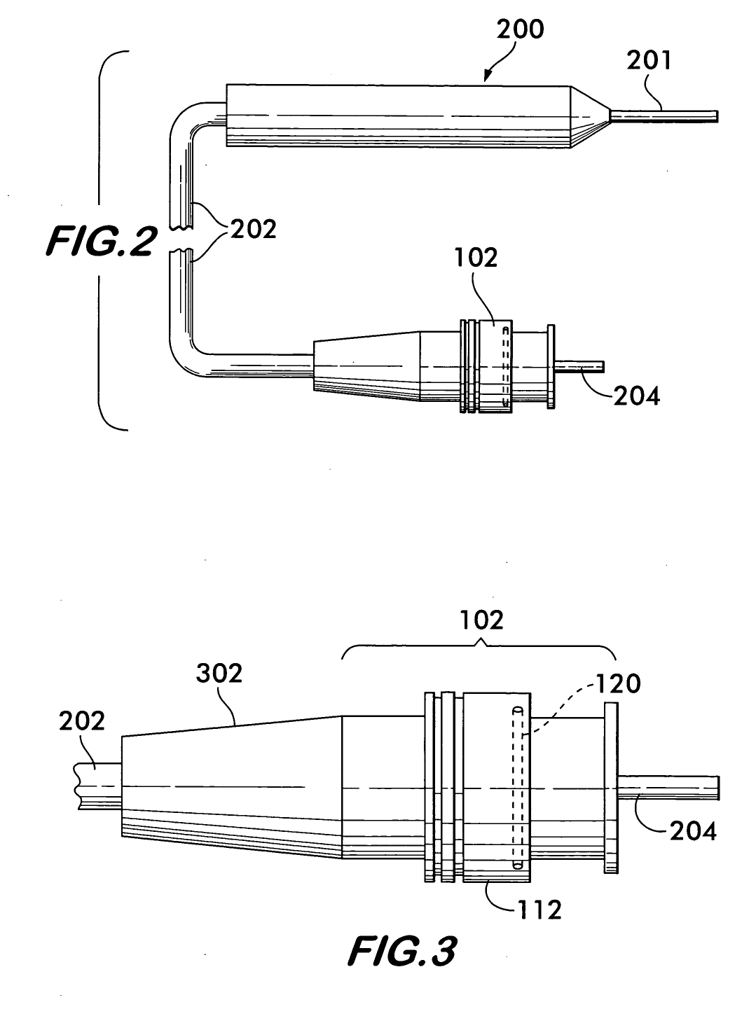

FIG. 1 is an exploded side view of an assembly 100 for connecting a connector 102 of an optic fiber instrument 200 (FIG. 2) to a connector 104 of a light source 106. Assembly 100 includes an adapter 108 configured to couple connector 102 to connector 104. Adapter 108 screws onto an externally threaded bushing 110 of light source 106. Once adapter 108 is attached to connector 104, adapter 108 can be inserted inside a collar 112 of connector 102. A groove 116 located on an external surface 118 of adapter 108 is positioned to engage one or more tube(s) 120 (shown as a broken line in FIG. 1) located inside collar 112, when adapter 108 is inserted far enough inside connector 102 for groove 116 and tube(s) 120 to engage each other. Tube(s) 120 are resiliently flexible rods that catch, and then snap into, groove 116 when groove 116 and tube(s) 120 engage each other. The engagement force of the resiliently biased tube(s) in groove 116 securely couples adapter 108 to connector 102. Accordingly, when tube(s) 120 snap into groove 116, adapter 108 is thereby coupled to connector 102.

As used herein a “tube” means any wire, rod, pipe, or related element configured to engage and fit inside groove 116. A tube may be solid and/or hollow. And a tube can be cylindrical and/or non-cylindrical in shape.

Having introduced various components of assembly 100, it is now possible to describe them and other features in more detail.

Optic Fiber Instrument

FIG. 2 illustrates a side view of an exemplary optic fiber instrument 200. In one implementation, optic fiber instrument 200 is used in ophthalmic microsurgery for delivering laser light to the interior of the eye. Alternatively, optic fiber instrument may be used for delivering illuminating light and/or be adapted for use on other anatomical structures and other surgical procedures. More details about optic fiber instruments and various components of such instruments are described in U.S. Pat. No. 6,357,932 entitled “Adapter For Coupling A BNC Connector to an SMA Bushing,” to Auld, (hereinafter the '932 patent) incorporated herein by reference in its entirety and U.S. Pat. No. 5,085,492 entitled “Optical Fiber With Electrical Encoding,” to Kelsoe et al. (hereinafter the '492 patent) also incorporated herein by reference in its entirety.

Light is transported to a tip 201 of optic fiber instrument 100 via an optical fiber 202. Typically, an external protective layer (not shown), such as cladding of various thickness and flexibility, protects one or more portions of optic fiber 202. Optic fiber 202 extends from tip 201 through connector 102 of optic fiber instrument 200 and into a center ferrule 204.

Connector of Optic Fiber Instrument

FIG. 3 illustrates a magnified side view of an exemplary connector 102. As mentioned above, connector 102 includes a collar 112. In one implementation, collar 112 is cylindrical in shape and constructed of a conductive material and/or non-conductive material. Alternatively, in other implementations, collar 112 may be of other shapes that are not necessarily cylindrical in shape, such as a square, hexagon, etc.

Collar 112 is mounted on a body 302 of connector 102. Center ferrule 204 projects from connector 102 through the center of collar 112. As is appreciated, the exterior of ferrule 204 is dimensioned to fit tightly in an alignment sleeve (shown in the '932 patent) of bushing 110 of light source 106 (FIG. 1).

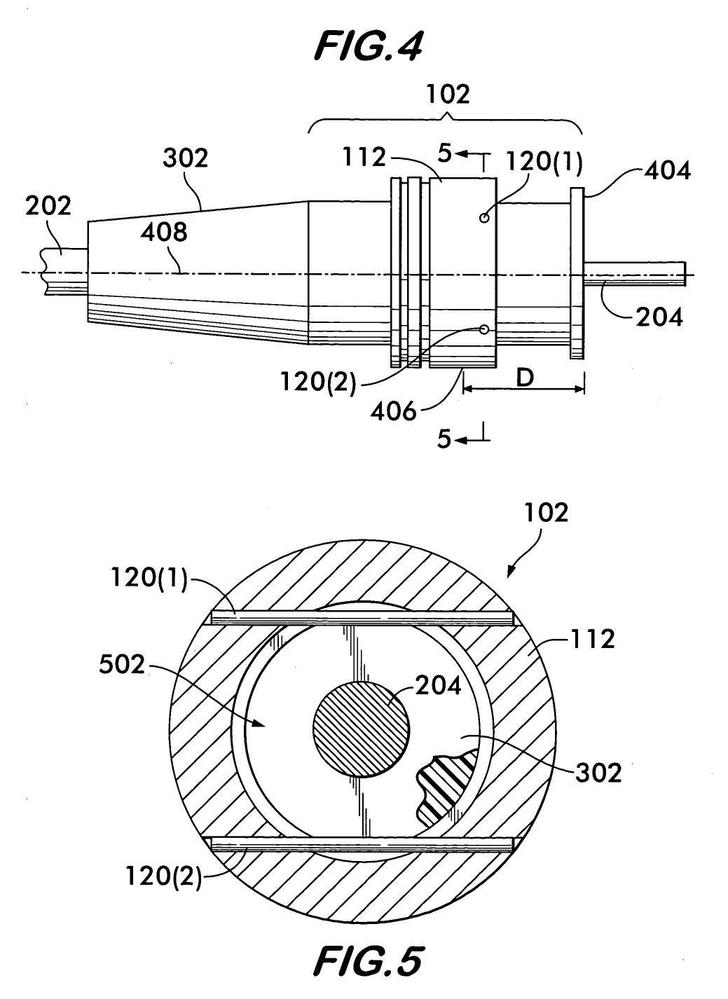

FIG. 4 illustrates another side view of an exemplary connector 102 that is rotated ninety degrees about its long axis from the view depicted in FIG. 3. In one implementation, tubes 120(1) and 120(2) extend through an internal portion of collar 112. Each tube, referred to generally as reference number 120, is configured to engage groove 116 (FIG. 1) of adapter 108 (FIG. 1). Although connector 102 includes two tubes in the exemplary implementation of FIG. 3, connector 102 may include a single tube, or more than two tubes in alternative implementations. Tubes 120 are typically perpendicular to a central axis 408 of collar 112.

It is noted that for approximately a distance, D, measured from a base 404 of collar 112 to a point 406, the interior of connector 102 is generally hollow, enabling at least a portion of adapter 108 (FIG. 1) to fit inside collar 112. Typically, collar 112 has a circumference (if cylindrical in shape) that is generally large enough to receive adapter 108 (FIG. 1). In one implementation, the distance D equals the total length of adapter 108 (FIG. 1), however, the distance D may be less than, or more than, the entire length of adapter 108.

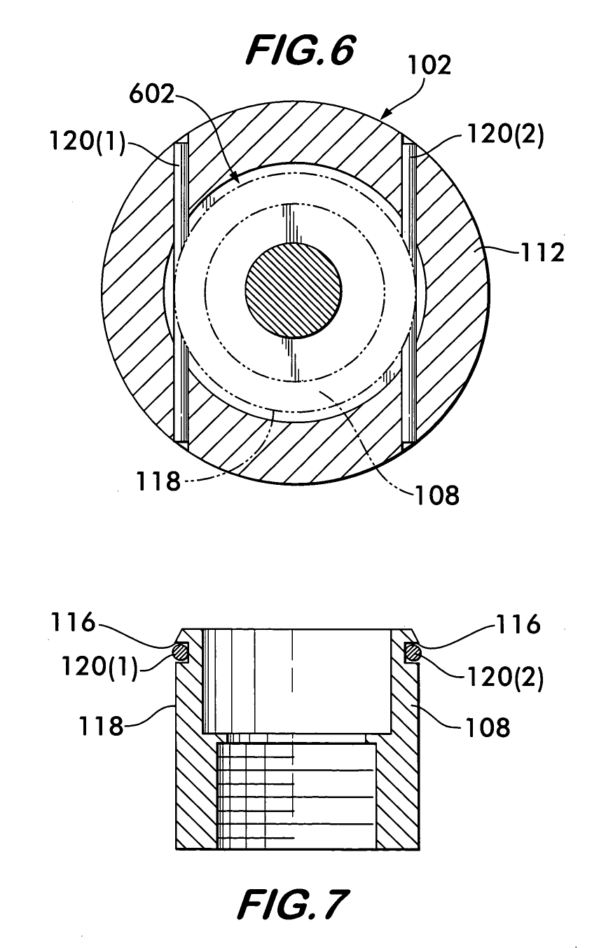

FIGS. 5 and 6 are cross-sectional views of connector 102. In particular, FIG. 5 shows an internal portion 502 of connector 102 depicting interrelation positions of center ferrule 204, body 302, collar 112 and tubes 120(1) and 120(2).

FIG. 6 shows an internal portion of connector 102 viewed from base 404 extending a distance D to point 406. As illustrated collar 112 forms an aperture 602 configured to receive adapter 108 (shown as a broken line). Portions of tubes 120(1) and 120(2) intersect a portion of aperture 602. External surface 118 (shown as broken line) of adapter 108 has a circumference (if cylindrical in shape) that extends beyond tubes 120(1) and 120(2). Accordingly, when adapter 108 (FIG. 1) is inserted into aperture 602, external surface 118 comes into contact with tubes 120 forcing them to flex outward and then flex back toward their original position when tubes 120 engage groove 116 (FIG. 1), i.e., snap into groove 116. The occurrence of the “snap” effectuates the coupling of adapter 108 to connector 102. A predetermined pulling force is needed to detach (i.e., separate) adapter 108 from connector 102 once they have been “snapped” together. The occurrence of the snap may be audible enabling medical technicians to know when the adapter is physically seated within the connector.

Connector of Optic Fiber Instrument and Adapter

FIG. 7 shows a longitudinal-sectional view of adapter 108, with tubes 120 engaged in groove 116. Groove 116 is generally large enough that portions of tubes 120 are able to fit inside. In one implementation, tubes 120 are constructed of NITINOL (Nickel Titanium Ordnance Laboratory) material properties. Alternatively, a tube may be constructed of other resilient and flexible materials such as steel or plastic. It is noted that only one tube 120 may be used in collar 112 (FIG. 6) if sufficiently strong, eliminating the use of two or more tubes. Additionally, tubes may be replaced entirely by a snap-ring (not shown) located in collar 112.

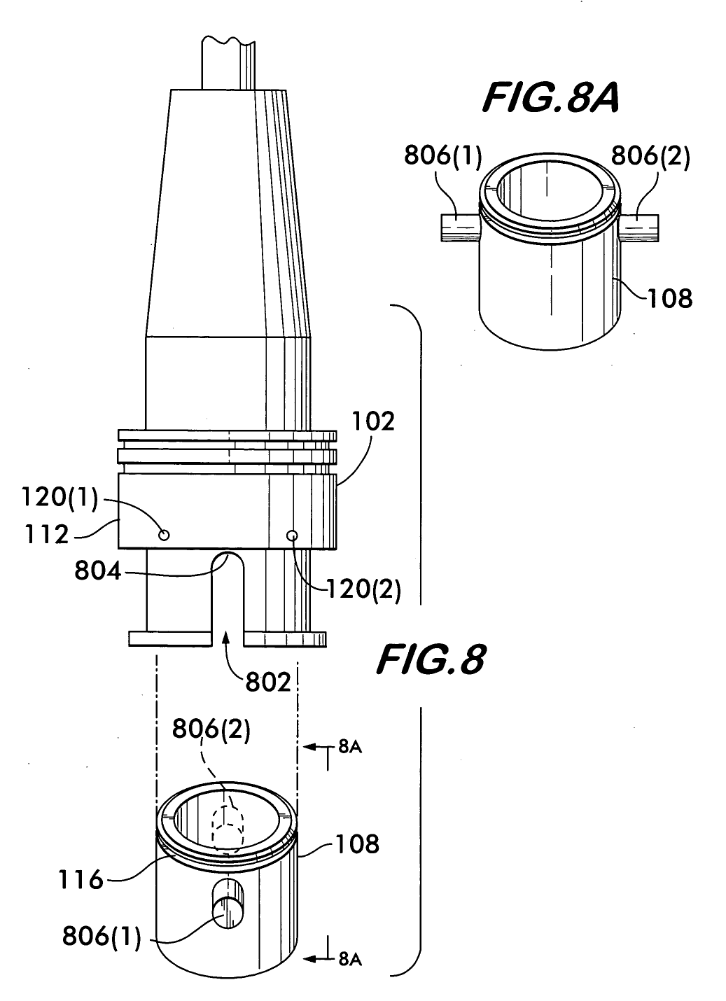

FIG. 8 shows a side view of connector 102 and a perspective view of adapter 108 according to an alternative implementation. In the exemplary implementation, depicted in FIG. 8, connector 102 may include one or more slots 802. Each slot 802 is generally straight and primarily for preventing adapter 108 from being inserted beyond a certain point in collar 112, i.e., from groove 116 going past tubes 120 when being inserted in collar 112. Typically, slot(s) 802 are dimensioned to be complementary to one or more posts 806(1) and 806(2) on the external surface 118 of adapter 108. In particular, a distal end 804 of each slot 802 is configured to stop posts, referred to generally as reference number 806, when the posts come into contact with each distal end 804. Accordingly, slot(s) 802 stop adapter 108 from being inserted beyond a certain point inside connector 102. Alternatively, other means may be used for preventing adapter 108 from being inserted beyond a certain point inside connector 102, such as a stopper (not shown) located inside connector 102.

Adapter and Light Source

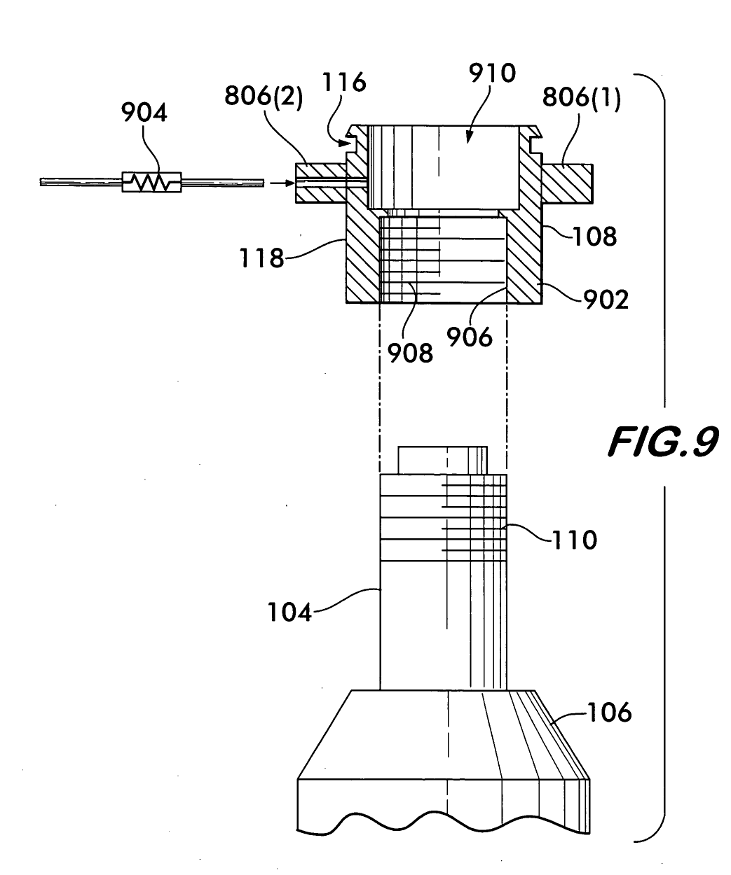

FIG. 9 illustrates a cross-sectional side view of an exemplary adapter used for connecting and disconnecting a connector of fiber optic instrument to a connector of a light source. Adapter 108 includes a sleeve 902. Sleeve 902 is generally cylindrical in shape, but may be other shapes, such as rectangular, hexagonal, or other non-cylindrical shapes. In one implementation, sleeve 902 is made of a conductive material such as steel. Alternatively, sleeve 902 may be composed of both conductive and/or non-conductive materials.

Sleeve 902 includes an external surface 118 having a groove 116. Relative to FIG. 9, groove 116 is positioned near the top of adapter 108. Alternatively groove 116 may be positioned in other locations along external surface 118.

Extending from external surface 118 are posts 806(1) and 806(2) located on the external surface 118 of sleeve 902. As mentioned before, posts are configured to fit inside one or more complementary slots of the connector. As mentioned above, posts 806 are configured to stop adapter 108 from being inserted beyond a certain point inside connector 102 (FIG. 1) when the one or more posts 806 reach a distal end 804 (FIG. 8) of the one or more complementary slots 802 (FIG. 8) of the connector 102. In one implementation, a resistor 904 or an equivalent electrical device may be inserted in one or more of posts 806 to ensure that a correct electrical circuit is established between light source 106 and optic fiber instrument 200 (FIG. 2). Alternatively resistor 904 or an equivalent device may be inserted in another location, such as inside adapter 108. Posts 806 may be integral to external surface 118 or attached thereto by solder or an equivalent attachment means.

Sleeve 902 includes an internal surface 906 that includes an internal screw threading 908 that is complementary to externally threaded bushing 110 of light source 106. Alternatively, sleeve 902 may include other coupling mechanisms, such as a pin, groove, slot, etc. that may engage another coupling component (other than bushing 110) of light source 106. Additionally, adapter 108 may be integral to light source 102, instead of using screw threading on the top of light source 106.

Once adapter 108 is attached to light source 106, center ferrule 204 (FIG. 2) from connector 102 may pass through the internal portion 910 of adapter 108 and into an alignment sleeve (not shown) of externally threaded bushing 110, thereby connecting light source 102 to optical fiber instrument 200 (FIG. 2).

It is recognized that various other components of assembly 100 may be used for various reasons and, for purposes of this discussion, any of these variety of components may be included. For instance, an annular stop, epoxy, electrical insulators, washers, etc. may all be used in conjunction with assembly 100, although not specifically shown in the figures.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. An adapter for connecting and disconnecting a light source to a connector of an optic fiber instrument, the connector containing a tube located inside the connector, the adapter comprising: a sleeve including an external surface having a groove positioned therein to engage the tube, such that when the sleeve is inserted inside the connector, the tube becomes seated in the groove, thereby coupling the adapter to the connector.

2. The adapter as recited in claim 1, wherein the sleeve is cylindrical.

3. The adapter as recited in claim 1, wherein the sleeve includes an internal surface having internal screw threading that is complementary to an externally threaded bushing of the light source to which the sleeve is also to be attached.

4. The adapter as recited in claim 1, wherein the groove is large enough that a portion of the tube fits inside the groove when the groove and tube are engaged.

5. The adapter as recited in claim 1, wherein the external surface of the sleeve flexes the tube as the sleeve is inserted inside the connector.

6. The adapter as recited in claim 1, wherein the external surface of the sleeve flexes the tube as the sleeve is inserted inside the connector, and when the groove and the tube engage each other, the flexed tube snaps into the groove.

7. The adapter as recited in claim 1, wherein the external surface of the sleeve flexes the tube as the sleeve of the adapter is inserted inside the connector, and when the groove and the tube engage each other, the tube snaps inside the groove eliciting an audible snapping sound.

8. The adapter as recited in claim 1, further comprising one or more posts located on the external surface of the sleeve.

9. The adapter as recited in claim 1, further comprising one or more posts located on the external surface of the sleeve configured to fit inside one or more complementary slots of the connector.

10. The adapter as recited in claim 1, further comprising one or more posts located on the external surface of the sleeve configured to fit inside one or more complementary slots of the connector and configured to stop the adapter from being inserted beyond a certain point inside the connector by action of the one or more posts reaching a distal end of the one or more complementary slots of the connector.

11. A connector of an optic fiber instrument for connecting to an adapter having a groove, the connector comprising: a collar having an internal portion configured to receive the adapter inserted therein, the internal portion including a tube configured to snap into the groove of the adapter when the adapter is inserted into the internal portion of the collar thereby coupling the adapter to the connector.

12. The connector as recited in claim 11, wherein the tube is formed of a flexible material.

13. The connector as recited in claim 11, wherein the tube comprises NITINOL.

14. The connector as recited in claim 11, wherein the internal portion of the collar is cylindrical.

15. The connector as recited in claim 11, wherein the tube is perpendicular to a center axis of the collar.

16. The connector as recited in claim 11, wherein the tube intersects the internal portion of the collar.

17. The connector as recited in claim 11, wherein the adapter travels along an insertion path in the internal portion of the collar and at least a portion of the tube projects across the insertion path enabling the adapter to engage the tube when the adapter is inserted into the collar.

18. The connector as recited in claim 11, wherein the tube is configured to fit within a portion of the groove.

19. The connector as recited in claim 11, further including at least one other tube located in the internal portion of the collar also configured to snap into the groove of the adapter, thereby coupling the adapter to the connector when the adapter is inserted into the internal portion of the collar.

20. An assembly, comprising:
an adapter for connecting and disconnecting a light source to an optic fiber instrument, the adapter including a sleeve having an external surface with a groove; and
a connector of the optic fiber instrument including a collar having an internal portion configured to receive the adapter inserted therein, the internal portion including a tube configured to snap into the groove of the adapter when the adapter is inserted into the internal portion of the collar, thereby coupling the adapter to the connector.

21. The assembly as recited in claim 20, wherein the external surface of the sleeve is cylindrical.

22. The assembly as recited in claim 20, wherein the sleeve includes an internal surface having internal screw threading that is complementary to an externally threaded bushing of the light source to which the sleeve is also to be attached.

23. The assembly as recited in claim 20, wherein the groove is large enough that a portion of the tube fits inside the groove when the groove and tube are engaged.

24. The assembly as recited in claim 20, wherein the external surface of the sleeve is configured to flex the tube when the sleeve of the adapter is inserted inside the connector.

25. The assembly as recited in claim 20, wherein the external surface of the sleeve is configured to flex the tube as the sleeve of the adapter is pushed inside the connector, and when the groove and the tube engage each other, the flexed tube snaps inside the groove.

26. The assembly as recited in claim 20, further comprising one or more posts located on the external surface of the sleeve.

27. The assembly as recited in claim 20, further comprising one or more posts located on the external surface of the sleeve configured to fit inside one or more complementary slots of the connector.

28. The assembly as recited in claim 20, further comprising one or more posts located on the external surface of the sleeve configured to fit inside one or more complementary slots of the connector and configured to stop the adapter from being inserted beyond a certain point inside the connector when the one or more posts reach a distal end of the one or more complementary slots of the connector.

29. The assembly as recited in claim 20, wherein the tube is comprised of a flexible material.

30. The assembly as recited in claim 20, wherein the tube is comprised of NITINOL.

31. The assembly as recited in claim 20, wherein the internal portion of the collar is cylindrical.

32. The assembly as recited in claim 20, wherein the tube is perpendicular to a center axis of the collar.

33. The assembly as recited in claim 20, wherein the tube intersects the internal portion of the collar.

34. An adapter for connecting and disconnecting a light source to a connector of an optic fiber instrument, the connector containing a catching member located inside the connector, the adapter comprising: a sleeve including an external surface having a groove positioned therein to engage the catching member, such that when the sleeve is inserted inside the connector, the catching member becomes seated in the groove, thereby coupling the adapter to the connector.

35. The adapter as recited in claim 34, wherein the catching member includes at least one tube.

36. The adapter as recited in claim 34, where in the catching member is part of a snap-ring mechanism.
